(19) United States
(12) Patent Application Publication
(10) Pub. No.: US 2016/0300233 A1
(43) Pub. Date: Oct. 13, 2016

(54) AN ELECTRONIC METHOD OF FRAUD PREVENTION

(71) Applicant: TOUCH NETWORKS AUSTRALIA PTY LTD, Melbourne, Victoria (AU)

(72) Inventor: Jason Andrew VAN, Melbourne, Victoria (AU)

(21) Appl. No.: 15/036,753

(22) PCT Filed: Nov. 13, 2014
(86) PCT No.: PCT/AU2014/001041

§ 371 Date: May 13, 2016

(30) Foreign Application Priority Data
Nov. 14, 2013 (AU) 2013904404

(51) Int. Cl. G06Q 20/40; G06Q 20/32; G06Q 40/02; G06Q 20/28

(52) U.S. Cl. CPC G06Q 20/4016; G06Q 20/28; G06Q 20/32; G06Q 20/3223; G06Q 40/02

(57) ABSTRACT

An electronic method of fraud prevention at a host system, comprises receiving, at a host system, a request to purchase one or more digital products and a request to settle the purchase by an Internet bank transfer. The host system connects the user to a third party system to enable the user to attempt to settle the purchase by making the Internet bank transfer from a bank account of a bank. The host system monitors the attempt to settle the purchase by an Internet bank transfer from the bank account to determine whether it is indicative of an unacceptable fraud risk, and terminates the transaction without releasing the requested one or more digital products in response to determining that the fraud risk is unacceptable.

### FIELD

The invention relates to an electronic method of fraud prevention in relation to transactions for digital goods.

### BACKGROUND

Selling digital goods, such as mobile phone recharge vouchers, over the Internet exposes the seller to significant fraud risks, in part because the digital goods are delivered very rapidly after completion of the financial transaction so that fraud must be detected in real-time before the transaction is completed so that intervention can take place before the digital goods are released.

In this respect, it will be appreciated that from the perspective of the seller computer system it can be difficult to discern the difference between a genuine user of the system, a human user using fraudulent details and a “bot”—i.e. a computer program designed to try to fraudulently obtain digital goods from a website.

To date the use of electronic banking to pay bills and the like has been a relatively low source of fraud, primarily because if fraud is detected subsequent to the transaction, debt recovery can be resumed. Accordingly, providing electronic access to a user's bank account to pay for digital goods carries the risk of increasing fraud levels in relation to electronic banking. As a result, there has been a reluctance to provide access to electronic banking as a means of settling payment in respect of on-line electronic purchase. As a result, electronic purchase are usually settled by credit card or an intermediary system such as PayPal.

Accordingly, there is a need for fraud mitigation in the context of electronic banking being used to pay for digital goods.

### SUMMARY

In a first aspect, the invention provides an electronic method of fraud prevention at a host system, the method comprising:
receiving, at a host system, a request to purchase one or more digital products,
receiving, at the host system, a request to settle the purchase by an Internet bank transfer;
connecting the user to a third party system to enable the user to attempt to settle the purchase by making the Internet bank transfer from a bank account of a bank;
monitoring, with the host system, the attempt to settle the purchase by an Internet bank transfer from the bank account to determine whether it is indicative of an unacceptable fraud risk; and
terminating, with the host system, the transaction without releasing the requested one or more digital products in response to determining that the fraud risk is unacceptable.

In an embodiment, monitoring the attempt to settle the purchase comprises:
receiving, from the third party system, an identifier unique to the bank account; and
processing the received identifier to assess a fraud risk of the transaction, the processing including determining whether any prior transactions associated with the received identifier are indicative of an unacceptable fraud risk.

In an embodiment, the third party system is configured to enable the user to specify details of the Internet bank transfer.

In an embodiment, the third party system enables the used to select a bank account from which funds are to be transferred by Internet bank transfer.

In an embodiment, the identifier is unique to the bank account but does not allow the host system to identify the bank account.

In an embodiment, monitoring the attempt to settle the purchase comprises monitoring completion of at least one web forms to determine whether a manner of completion of the at least one web form is indicative of the at least one web form not being completed by a human user.

In an embodiment, the digital product is a mobile device recharge voucher.

In a second aspect, the invention provides a host system for fraud prevention, the host system comprising:
a purchase request receiver configured to receive a request to purchase one or more digital products,
a payment module configured to receive a request to settle the purchase by an Internet bank transfer, the payment module configured to connect the user to a third party system associated with a bank to thereby enable the user to attempt to settle the purchase by making the Internet bank transfer from a bank account of the bank;
a transaction monitor configured to monitor the attempt to settle the purchase by an Internet bank transfer from the bank account to determine whether it is indicative of an unacceptable fraud risk; and
a transaction terminator configured to terminate the transaction without releasing the requested one or more digital products in response to determining that the fraud risk is unacceptable.

In an embodiment, the transaction monitor monitors the attempt to settle the purchase by:
receiving an identifier unique to the bank account from the third party system; and
processing the received identifier to assess a fraud risk of the transaction, the processing including determining whether any prior transactions associated with the received identifier are indicative of an unacceptable fraud risk.

In an embodiment, the third party system is configured to enable the user to specify details of the Internet bank transfer.

In an embodiment, the third party system enables the used to select a bank account from which funds are to be transferred by Internet bank transfer.

In an embodiment, the identifier is unique to the bank account but does not allow the host system to identify the bank account.

In an embodiment, the transaction monitor is configured to monitor the attempt to settle the purchase by monitoring completion of at least one web form to determine whether a manner of completion of the at least one web form is indicative of the at least one web form not being completed by a human user.

In an embodiment, the digital product is a mobile device recharge voucher.

The invention also provides computer program code which when executed implements the above method and a tangible computer readable medium comprising the computer program.

### BRIEF DESCRIPTION OF THE DRAWINGS

FIG. 1 is a flowchart of an embodiment for fraud detection during payment by bank account for a mobile phone recharge;

FIG. 2 is a flowchart of an embodiment for fraud detection during payment by bank account for the purchase of other digital products;

FIGS. 3 to 12 are examples of user interfaces for use in the method of FIG. 1;

FIG. 13 is one example of a system for implementing the method of FIG. 1; and

FIG. 14 shows further detail of the host system of FIG. 13.

### DETAILED DESCRIPTION

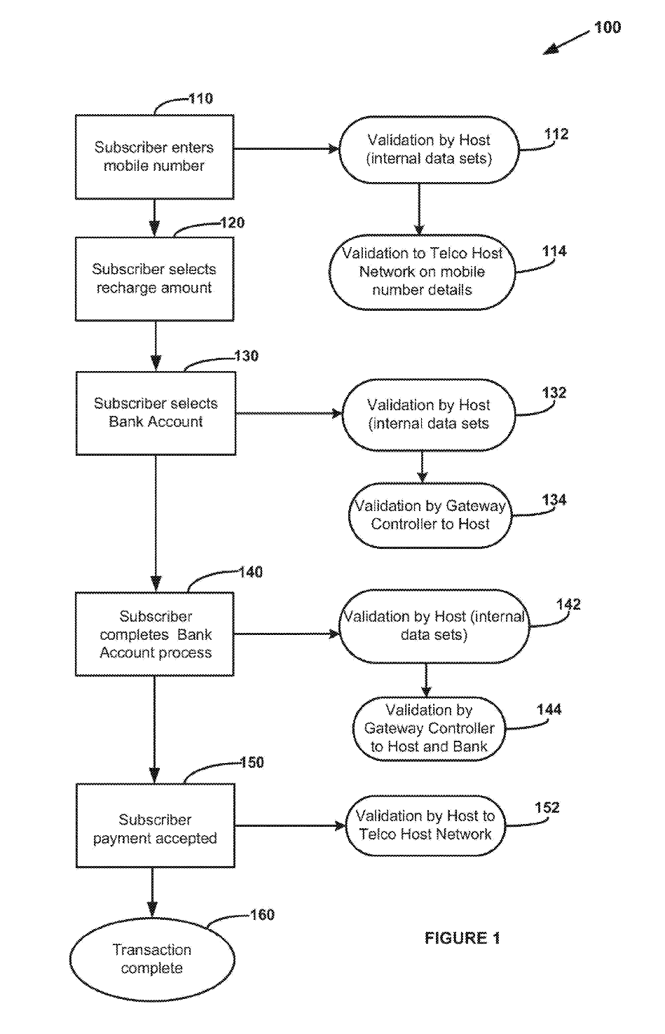

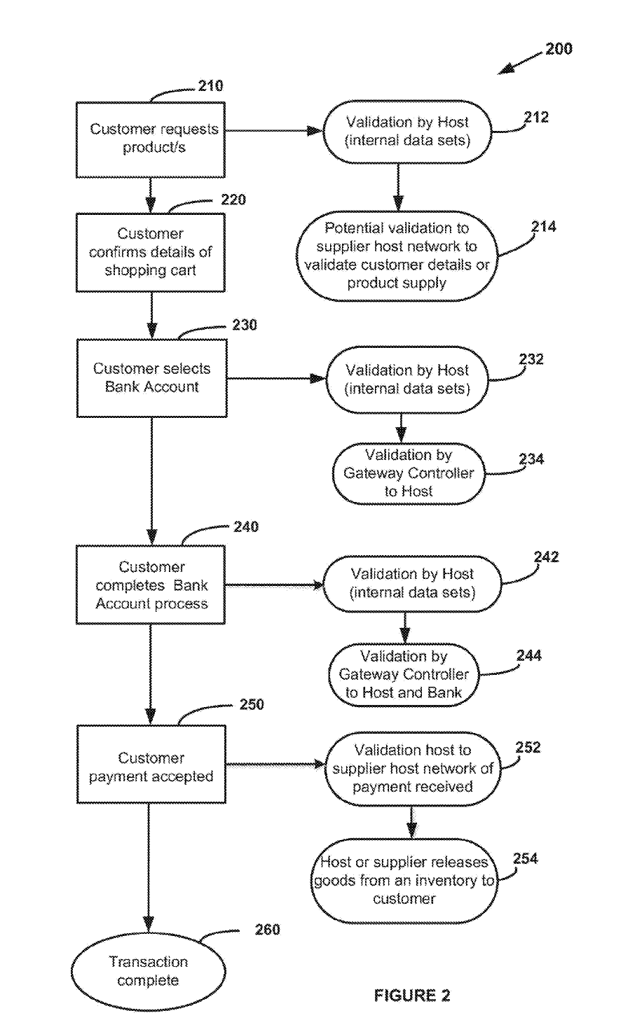

One embodiment illustrated in FIG. 1 relates to a method for preventing fraud when a user is paying for mobile prepaid recharge vouchers in real-time by accessing their bank account and selecting a bank account with which to complete the transaction. As shown in FIG. 2, the method can be extended, in another embodiment, to the purchase of other digital goods.

Referring to FIG. 1, in the method of the embodiment, the user (also referred to as a subscriber) initiates a prepaid mobile phone recharge process by entering a mobile phone number 110. The user then selects a recharge amount 120 and a payment method. FIG. 1 shows the case where the user selects to pay using their bank account 130 and enters relevant details for a valid transaction 140. From the user's perspective, the payment is then accepted 150 and the transaction is complete 160.

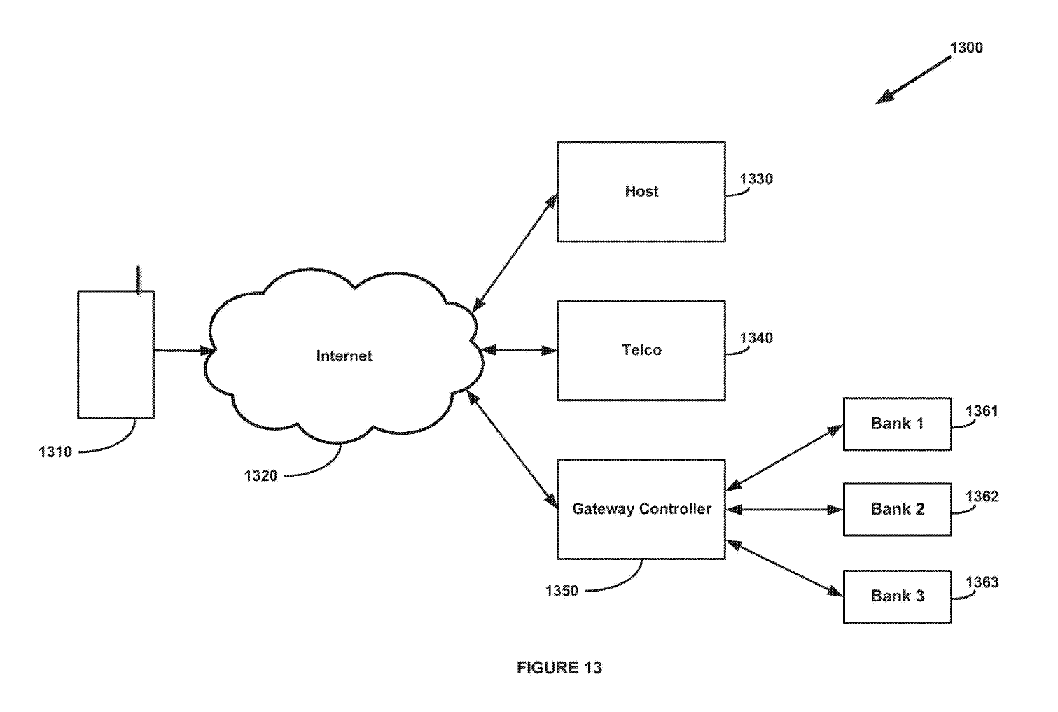

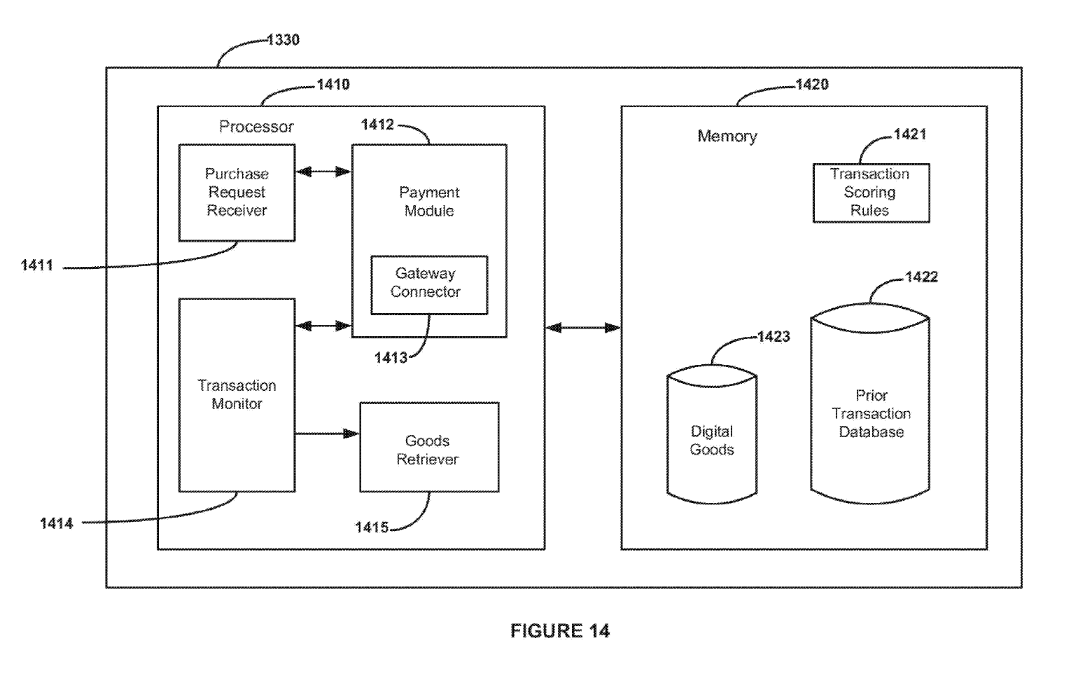

While the process 100 is being undertaken from the user's perspective, a number of additional steps are occurring in the background. In this respect, a host system 1330 (see FIGS. 13 and 14) has a purchase request receiver 1411 which present a web site to users via which users can purchase mobile device recharge vouchers that the host system can release to the user from digital goods database 1423 stored in a memory 1420 of the host system. The host system 1330 is configured to engage in a number of validation processes while the user attempts to make their purchase. The first validation process 112 is based on data associated with the mobile device and the origin of the request. The first validation process 112 takes into account data such as the location of the user's device, the identification of the device, previous interactions with the device (such as the number of completed, abandoned or unsuccessful transactions), an IP address from which the request is received, the mobile number and other existing attributes maintained in the host server 1330. The host system 1330 assigns a score to the device based on these factors using transaction scoring rules 1421 and the score is compared against defined values to determine whether to allow the transaction to continue. If fraud is detected at this stage or at a later stage in the transaction, the transaction is terminated before the transaction completes.

The host 1330 also sends a validation request 114 to the telecommunication network 1340 associated with the mobile number to ask it to confirm that the phone number is registered with the network.

When the user selects a bank account 130, a further monitoring of the transaction occurs by the host 1330. In the embodiment, the transaction with the bank is carried out under control of a third party system in the form of gateway controller 1350 which provides a gateway to each of a plurality of banks 1361, 1362, 1363 shown in FIG. 13. Accordingly, when a payment module 1412 implemented by processor 1410 of host system 1330, receives a request for payment by Internet bank transfer, gateway connector 1413, connects the user to the gateway controller 1350. In another embodiment, there may be separate gateway controllers of each bank

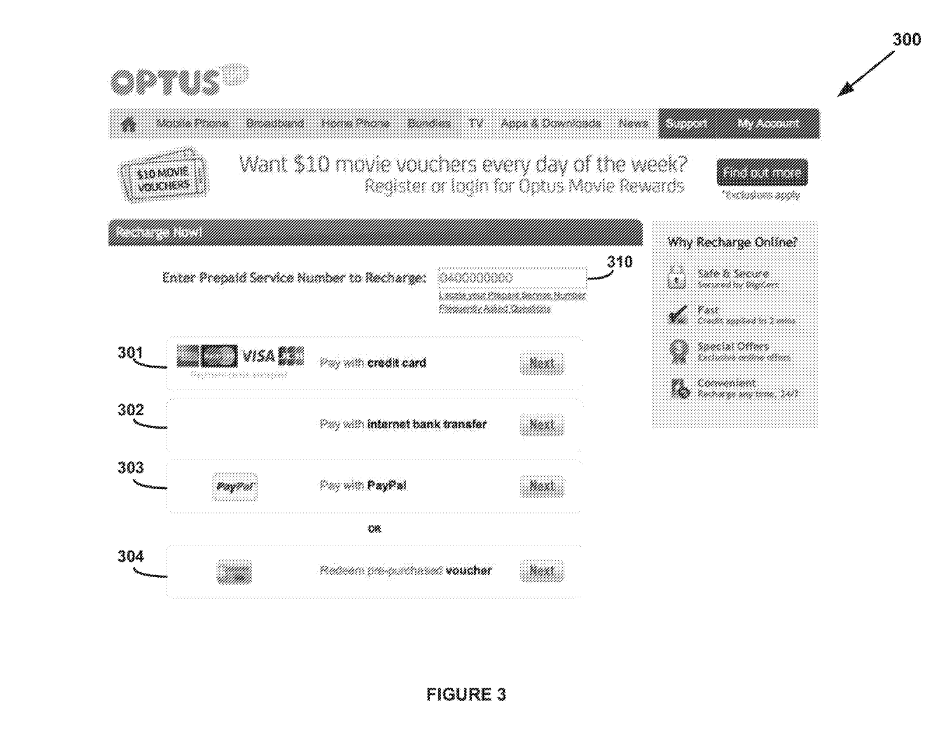

In order to validate the transaction, a transaction monitor 1414 of the host system monitors the transaction. The monitoring includes the transaction monitor 1414 obtaining an identifier from the gateway controller 1350 which does not identify the bank account but is unique to the bank account. The host system conducts a further scoring of the transaction based on any data associated with the identifier in the prior transaction database 1422. For example, based on whether it has been used in other transactions. The gateway controller 1350 conducts a separate validation (e.g. to confirm that the log-in details are correct) and report the outcome to the host 1330. As the user completes the bank account process an additional validation process is conducted 142 by the transaction monitor 1414. This process may involve observing how the user attempts to complete the forms shown in FIGS. 3 to 12 with a view to confirming that the behaviour in completing the forms is consistent with the user being a human and not a “bot”. For example, “bots” are sometimes configured to read the source code of a web page to determine how to complete the page and, in the course of doing so, may make an error that a human is unlikely to make, for example attempting to a select a shape in background text in an image that resembles a text entry box. In step 144, the gateway controller 1350 validates the entered details against those held by the bank 1361, 1362, 1363 and confirms to the host that the funds can be reserved to be provided to the host system 1332. Finally, when the user's payment is accepted, the telecommunication network 152 is instructed to update its records 152 by the host 1330. At this point the voucher is provided to the user by goods releaser which releases the voucher from digital goods database 1423.

An analogous approach occurs in the generalised method 200 of selling digital products such as Apple iTunes vouchers, software licenses etc. In this process, the customer requests products 210 which can lead to a validation step 212 and, optionally, to request a validation to the supplier host network (equivalent to the Telco network 1340 of the first embodiment) to validate customer details or to advise whether the product can be supplied. The customer then confirms the details of the shopping cart 210 and selects a bank account and completes a bank account process 240 from which payment may be accepted 250 in order to complete the transaction 260 in a manner analogous to that performed in the mobile recharge method of FIG. 1. Accordingly, validation steps 232, 234, 242 and 244 are equivalent to validation steps 132, 134, 142 and 144 as are validation steps. However, it will be noted that in addition to the validation to the supplier host network of payment being received, there is an additional step of the supplier releasing goods 254 from an inventory to the customer.

FIGS. 3 to 12 illustrate an example of a user interface for engaging in a recharge process. At a first user interface for initiating the recharge process 300 a user enters their prepaid service number into a box 310. In this example, the number entered is “040000000”. The user then has a number of repayment options including to pay by credit card 301, internet bank transfer 302, PayPal 303, or a voucher 304.

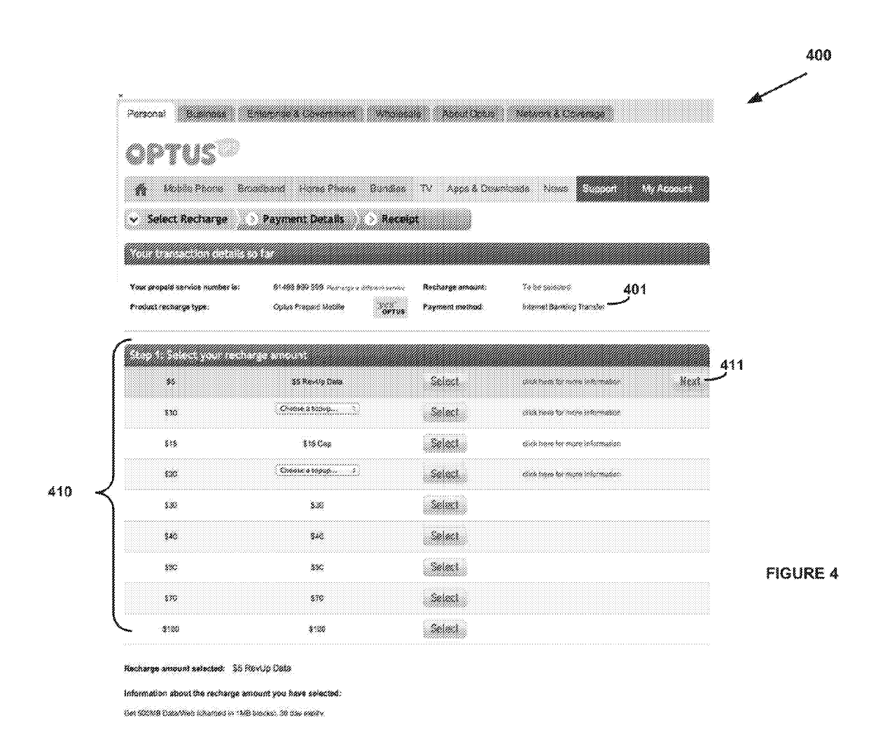

FIG. 4 shows the screen that is displayed after the user has selected to pay by internet bank transfer 302 in FIG. 3. In this respect, it will be apparent that the payment method is indicated as internet banking transfer 401. The user has a set of possible recharge amounts 410 and in this case has selected the “$5.00 rev-up data” option and moves to the next screen by selecting the next button 411.

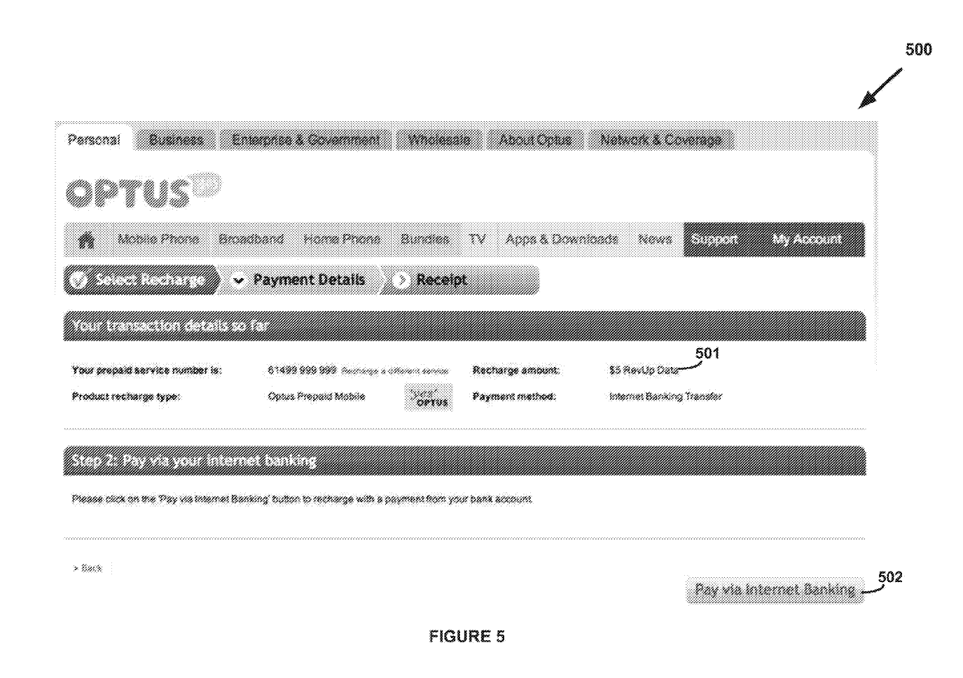

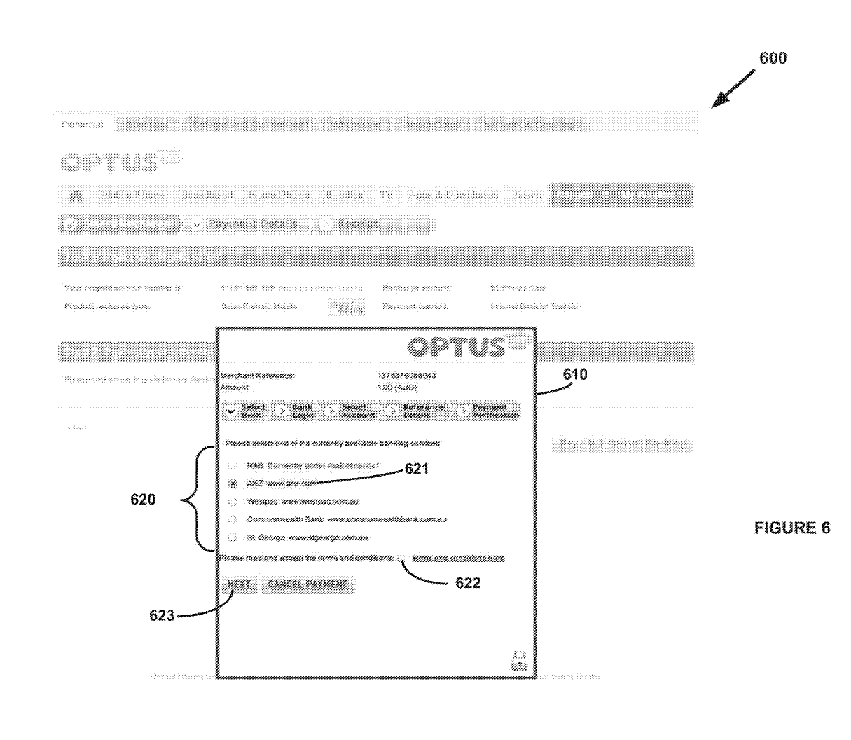

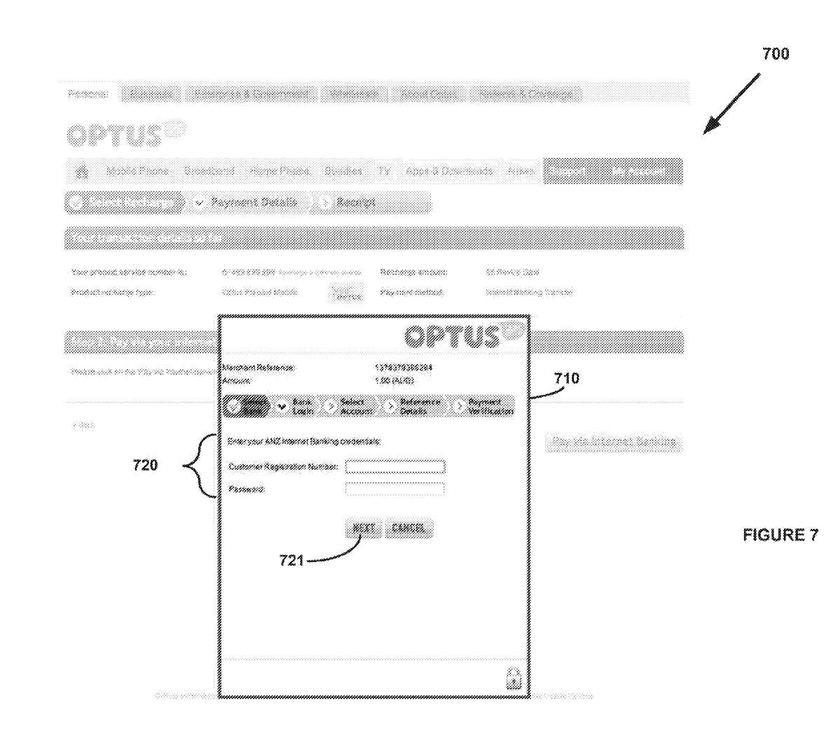

In FIG. 5, the user selection of the $5.00 rev up data option is indicated 501 and the user is asked to confirm that they should pay via internet banking 502. Upon selection of internet banking, the screen is modified by adding the light box 610 shown in FIG. 6. In box 610, the user has been presented with a number of participating banking institution options 620 and has selected to pay via the ANZ bank as indicated by selection icon 621. In the embodiment, the user must confirm that they accept the terms and conditions 622 and then can proceed to the next stage by selecting the next button 623. As is shown in FIG. 7, the user interface 700 continues to display details of internet banking in light box 710 which has been modified to include a request for customer details specific to the ANZ banking system 720 and the user is required to enter those details before moving to the next screen using the next button 721.

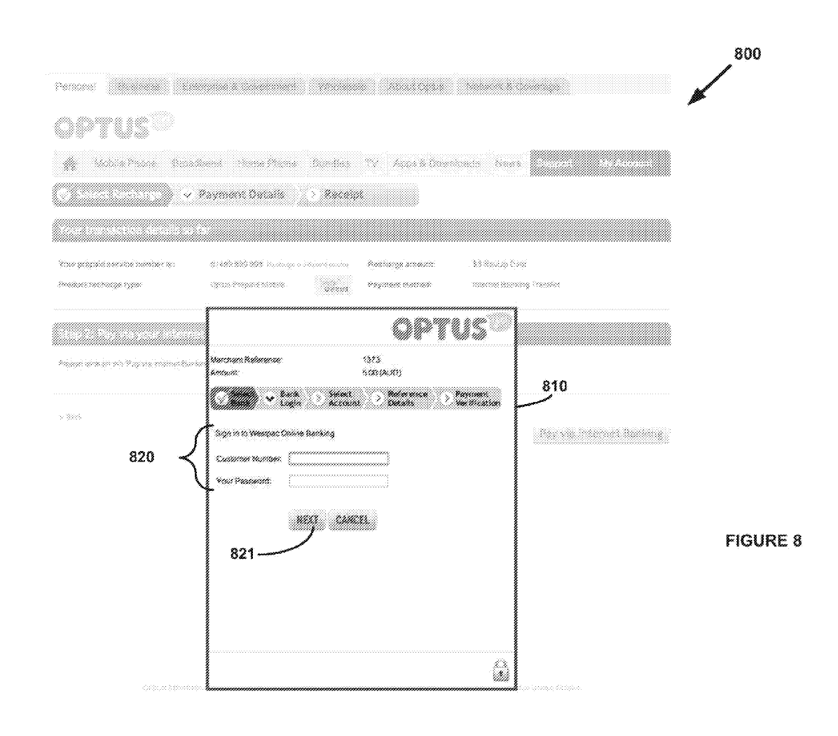

FIG. 8 shows an alternative display where the light box 810 is updated to show alternative display information for the Westpac Bank from which it will be apparent that the data displayed in the bank login stage illustrated in FIGS. 7 and 8 will vary depending on the selected bank.

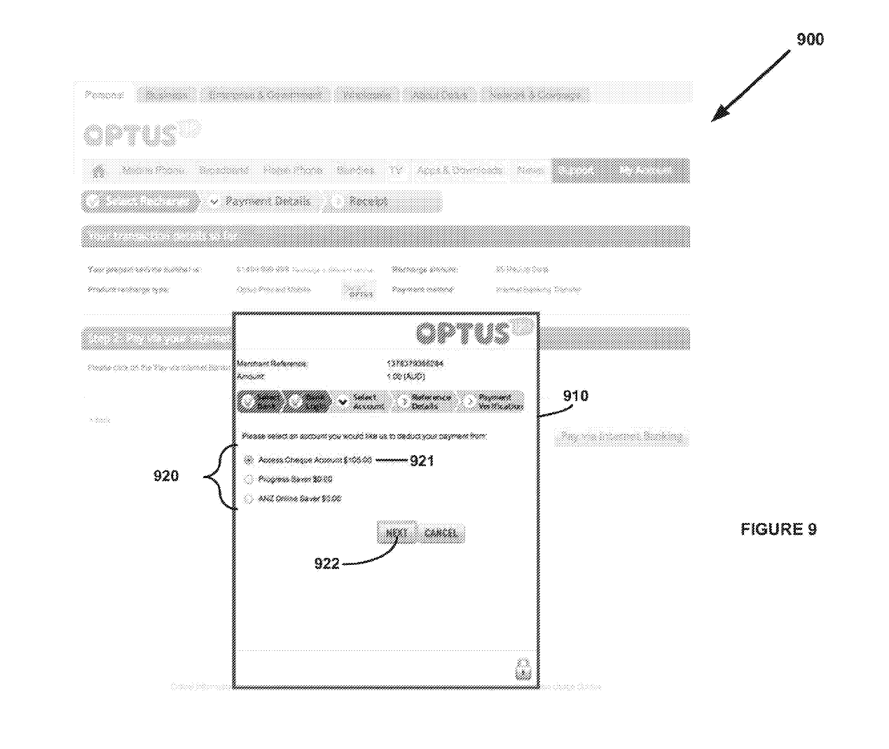

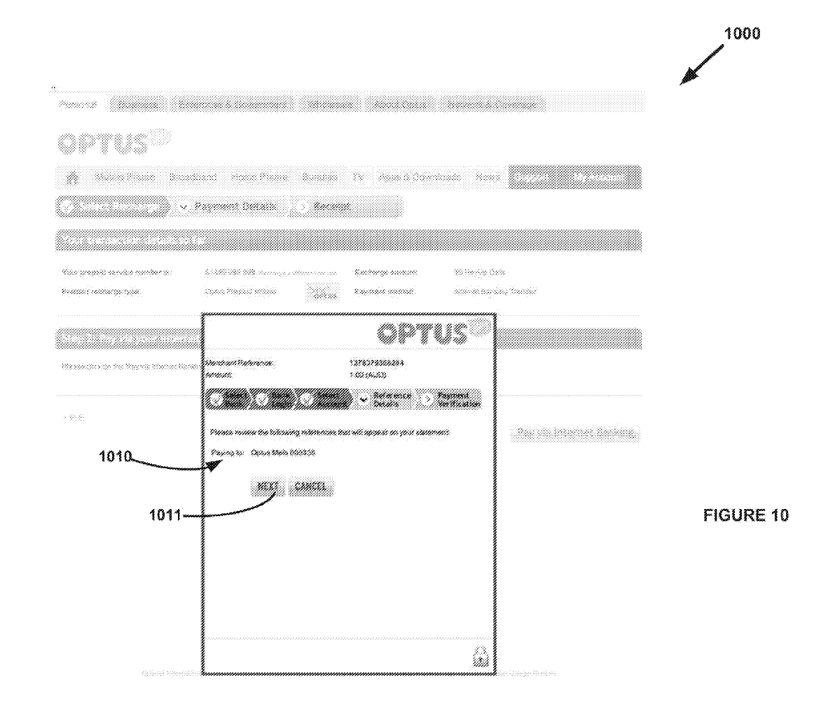

Referring to FIG. 9, the user has progressed to the stage selecting an account as indicated in light box 910 and is offered the option to select between three different accounts 920 having different balances. The user has selected the “access cheque account” 921 and proceeds to the next screen by clicking on the next button. The user is then provided with reference details 1010 in FIG. 10 and moves to the next screen by pressing the “next” button.

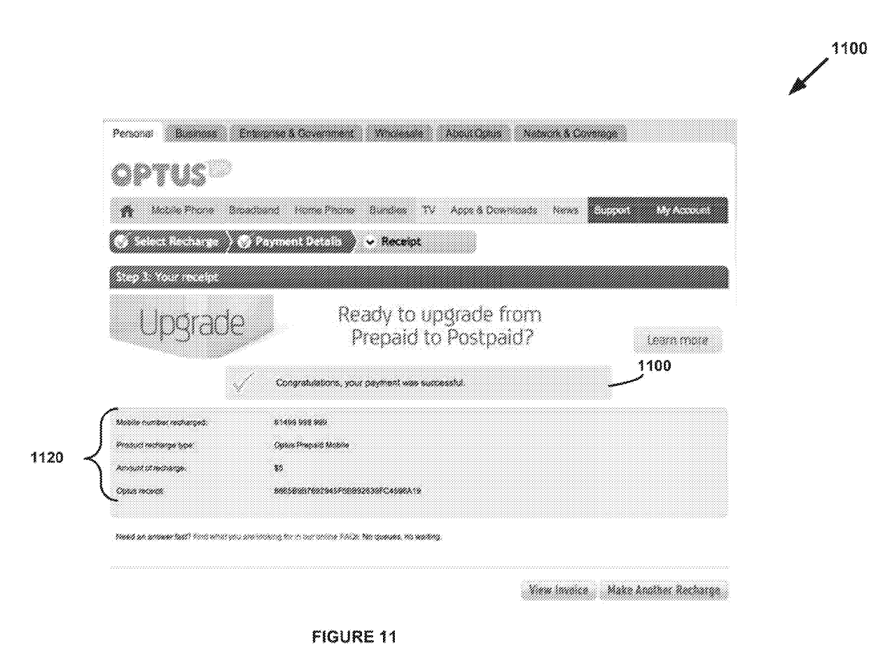

In FIG. 11, the user interface is updated to remove the light box and the user receives a payment verification message 1110 as well as details of the payment 1120.

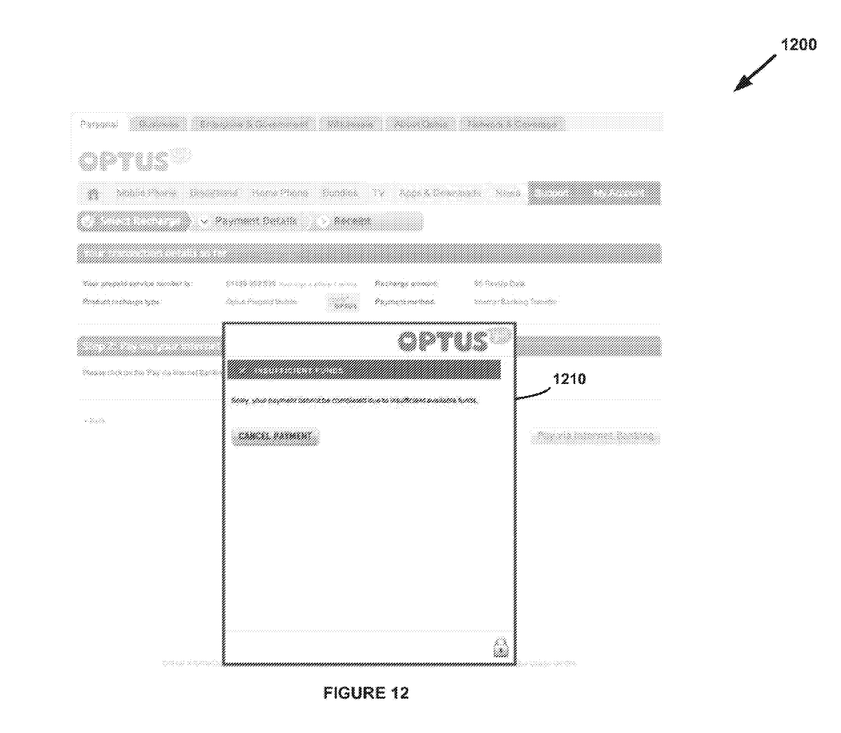

FIG. 12 illustrates that if the user has insufficient funds they will receive an error message 1210. Similar error messages will be displayed if the user makes other errors when entering the data or if the transaction is to be declined because the fraud risk is too high.

FIG. 13 shows an example of an architecture for implementing the invention. In FIG. 13 the system 1300 involves a mobile device 1310 communicating via the Internet with the host system 1330. The host also communicates with the Telco network 1340 and the gateway controller 1350 via the Internet 1320. The gateway controller communicates directly with the first, second and nth banks 1361, 1362, 1363 via a private network.

Persons skilled in the art will appreciate that in the case of more general supply of the electronic goods, the Telco 1340 can be replaced by one or more suppliers. Further, alternative types of devices can be used to access the host 1330 such as personal computers whether in the generalised digital goods process or for the recharge process.

Further aspects of the method will be apparent from the above description of the system. It will be appreciated that at least part of the method will be implemented electronically, for example, digitally by a processor executing program code. In this respect, in the above description certain steps are described as being carried out by the host system. It will be appreciated that these steps will be carried out by software executed by one or more processors, for example using an appropriately configure computer server. It will be appreciated that such steps will often require a number of sub-steps to be carried out for the steps to be implemented electronically, for example due to hardware or programming limitations. For example, to carry out a step such as evaluating, determining or selecting, a processor may need to compute several values and compare those values.

As indicated above, the method may be embodied in program code. The program code could be supplied in a number of ways, for example on a tangible computer readable storage medium, such as a disc or a memory device, e.g. an EEPROM, (for example, that could replace part of memory 103) or as a data signal (for example, by transmitting it from a server). Further different parts of the program code can be executed by different devices, for example in a client server relationship. Persons skilled in the art, will appreciate that program code provides a series of instructions executable by the processor.

Herein the term “processor” is used to refer generically to any device that can process instructions and may include: a microprocessor, microcontroller, programmable logic device or other computational device, a general purpose computer (e.g. a PC) or a server. That is a processor may be provided by any suitable logic circuitry for receiving inputs, processing them in accordance with instructions stored in memory and generating outputs (for example on the display). Such processors are sometimes also referred to as central processing units (CPUs). Most processors are general purpose units, however, it is also know to provide a specific purpose processor, for example, an application specific integrated circuit (ASIC) or a field programmable gate array (FPGA).

It will be understood to persons skilled in the art of the invention that many modifications may be made without departing from the spirit and scope of the invention; in particular it will be apparent that certain features of embodiments of the invention can be employed to form further embodiments.

It is to be understood that, if any prior art is referred to herein, such reference does not constitute an admission that the prior art forms a part of the common general knowledge in the art in any country.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

1. An electronic method of fraud prevention at a host system, the method comprising:
receiving, at a host system, a request to purchase one or more digital products,
receiving, at the host system, a request to settle the purchase by an Internet bank transfer;
connecting the user to a third party system to enable the user to attempt to settle the purchase by making the Internet bank transfer from a bank account of a bank;
monitoring, with the host system, the attempt to settle the purchase by an Internet bank transfer from the bank account to determine whether it is indicative of an unacceptable fraud risk; and
terminating, with the host system, the transaction without releasing the requested one or more digital products in response to determining that the fraud risk is unacceptable.

2. A method as claimed in claim 1, wherein monitoring the attempt to settle the purchase comprises:
receiving, from the third party system, an identifier unique to the bank account; and
processing the received identifier to assess a fraud risk of the transaction, the processing including determining whether any prior transactions associated with the received identifier are indicative of an unacceptable fraud risk.

3. A method as claimed in claim 1 or claim 2, wherein the third party system is configured to enable the user to specify details of the Internet bank transfer.

4. A method as claimed any one of claims 1 to 3, wherein the third party system enables the used to select a bank account rom which funds are to be transferred by Internet bank transfer.

5. A method as claimed in any one of claims 1 to 4, wherein the identifier is unique to the bank account but does not allow the host system to identify the bank account.

6. A method as claimed in any one of claims 1 to 5, wherein monitoring the attempt to settle the purchase comprises monitoring completion of at least one web form to determine whether a manner of completion of the at least one web form is indicative of the at least one web form not being completed by a human use.

7. A method as claimed in any one of claims 1 to 6, wherein the digital product is a mobile device recharge voucher.

8. A host system for fraud prevention, the host system comprising:
a purchase request receiver configured to receive a request to purchase one or more digital products,
a payment module configured to receive a request to settle the purchase by an Internet bank transfer, the payment module configured to connect the user to a third party system associated with a bank to thereby enable the user to attempt to settle the purchase by making the Internet bank transfer from a bank account of the bank;
a transaction monitor configured to monitor the attempt to settle the purchase by an Internet bank transfer from the bank account to determine whether it is indicative of an unacceptable fraud risk; and
a transaction terminator configured to terminate the transaction without releasing the requested one or more digital products in response to determining that the fraud risk is unacceptable.

9. A host system as claimed in claim 8, wherein the transaction monitor monitors the attempt to settle the purchase by:
receiving an identifier unique to the bank account from the third party system; and
processing the received identifier to assess a fraud risk of the transaction, the processing including determining whether any prior transactions associated with the received identifier are indicative of an unacceptable fraud risk.

10. A host system as claimed in claim 8 or claim 9, wherein the third party system is configured to enable the user to specify details of the Internet bank transfer.

11. A host yste s claimed in any one of claims 8 to 10, wherein the third party system enables the used to select a bank account from which funds are to be transferred by Internet bank transfer.

12. A host system as claimed in any one of claima 8 to 11, wherein the identifier is unique to the bank account but does not allow the host system to identify the bank account.

13. A host system as claimed in any one of claims 8 to 12, wherein the transaction monitor is configured to monitor the attempt to settle the purchase by monitoring completion of at least one web form to determine whether a manner of completion of the at least one web form is indicative of the at least one web form not being completed by a human user.

14. A host system as claimed in any one of claims 8 to 13, wherein the digital product is a mobile device recharge voucher.

15. Computer program code which when executed implements the method of any one of claims 1 to 7.

16. A tangible computer readable medium comprising the computer program code of claim 15.
